(19) United States
(12) Patent Application Publication
(10) Pub. No.: US 2011/0046783 A1
(43) Pub. Date: Feb. 24, 2011

(54) METHOD FOR TRAINING A ROBOT OR THE LIKE, AND DEVICE FOR IMPLEMENTING SAID METHOD

(75) Inventor: Laredj Benchikh, Saint Pierre du Perray (FR)

Correspondence Address: DAVIS & BUJOLD, P.L.L.C., 112 PLEASANT STREET, CONCORD, NH, 03301, US

(73) Assignee: BLM SA, Etupes (FR)

(21) Appl. No.: 12/812,792

(22) PCT Filed: Jan. 15, 2009
(86) PCT No.: PCT/IB2009/000066

§ 371 Date: Nov. 2, 2010

(30) Foreign Application Priority Data
Jan. 15, 2008 (FR) 08/00209

(51) Int. Cl. G05B 19/04

(52) U.S. Cl. 700/254

(57) ABSTRACT

A device for training a robot adapted to carry out automated tasks in order to accomplish various functions, in particular at least one of processing, mounting, packaging or maintaining tasks, using a specific tool on a part. The device includes a way for displaying the part as a 3D virtual model and for controlled movement of the specific tool of the robot. At least one virtual guide is associated with the 3D model of the part, defining a space arranged for delimiting an approach path of the tool to a predetermined operation area of the 3D model of the part. The predetermined operation area is associated with the virtual guide. The device stores, in a computer, spacial coordinates of the tool with respect to a given coordinate system in which the 3D model of the part is positioned when the tool is effectively located in the predetermined operation area.

This application is a National Stage completion of PCT/IB2009/000066 filed Jan. 15, 2009, which claims priority from French patent application Ser. No. 08/00209 filed Jan. 15, 2008.

### FIELD OF THE INVENTION

The invention relates to a method for training a robot or the like, wherein this robot is adapted to carry out automated tasks in order to accomplish various functions, in particular processing, mounting, packaging or maintaining tasks, using a specific tool, on a part, the training being performed in order to define precisely the movements of a specific tool of the robot, required within the framework of the tasks to be carried out on the part and to store the parameters of the movements of the specific tool of the robot.

The invention also relates to a device for training a robot or the like, for the implementation of the method, this robot being arranged to carry out automated tasks in order to accomplish various functions, in particular processing, mounting, packaging or maintaining tasks, using a specific tool, on a part, the training being performed in order to define precisely the movements of a specific tool of this robot, required within the framework of its tasks and consisting in determining and storing the parameters of these movements.

### BACKGROUND OF THE INVENTION

In the branch commonly called “Robotic CAD” in the industrial area, that is to say the computer-aided design of robots, the programming of these robots is usually carried out in an exclusively virtual environment, which generates considerable differences with respect to reality. In fact, the virtual robot that stems from a register called predefined library is always a “perfect” robot, which does not take into consideration any manufacturing or operating tolerances. One will therefore note in practice large differences between the perfect paths followed by the virtual robot in compliance with its programming and the real paths followed by the real robot with its defects. This fact obliges the users to make modifications in many points of the path when setting up the program with a real robot. These differences are due to the fact that the virtual robot is not a faithful image of the real robot because of mechanical plays, manufacturing tolerances, mechanical wear or similar reasons, which do not exist in the virtual world.

Another disadvantage of this method comes from the fact that the movement of the accessory components, often referred to by the name “fittings” on board of the robot, such as cables, hoses, covers, etc., cannot be simulated with CAD since these accessory components are obligatorily fixed. This is likely to lead to interferences and collisions with a real part on which the robot is to work when loading the program on the real robot, even when corrective changes have possibly been made.

On the other hand, the robot cycle times calculated by a CAD are approximate, since they are linked with the sampling and time calculation frequency of the computer, this time being different from that determined by the robot. In other words, the time base of the computer can be different from that of the robot.

Another training mode is often used. This is the so-called manual training. The main disadvantage of the manual programming is that it is an approximate programming, since it is carried out with the eye of the operator and requires continuous modifications during the whole lifetime of the part processed by the robot in order to achieve optimum operation. Furthermore, this technique requires the presence of the real part to be able to carry out the training, and this can create many problems. On the one hand, in certain sectors such as for instance the automotive industry, the realization of one or even several successive prototypes entails excessively high costs, and extremely long manufacturing times. Furthermore, the manufacturing of prototypes in this area poses very complex problems regarding confidentiality. Finally, the training based on a real part must take place obligatorily besides the robot and cannot be remote-controlled; this leads to risks of collisions between the robot and the operator.

All the above-mentioned questions are serious disadvantages, which lead to high costs, to long lead times and do not allow obtaining technically satisfying solutions. The problem of programming or training robots is all the more complicated since the shape of the objects the robots are to work on are more complex. Now, theoretically, the robots are advantageous precisely for complex shapes. The current programming modes are brakes as regards costs and lead times for the application of the robots. Furthermore, the programming work requires very high-level specialists, having great experience in their branch of activity.

Several industrial robot path training help methods are known, in particular from the American publication US 2004/0189631 A1, which describes a method using virtual guides that are materialized by means of an enhanced reality technique. In this case, these virtual guides are applied on real parts, for example a real prototype of a motor vehicle body arranged in a robotic line. The goal of this technique is to help the operators to teach the paths of the robots faster, but it does not allow carrying out the remote training of a robot, without having a model of the part to process, excluding any risk of a personal accident of the operator and eliminating the need to build a prototype.

The publication U.S. Pat. No. 6,204,620 B1 relates to a method using conical virtual guides associated to special machines or industrial robots, the role of these guides being to reduce the movement range of the robots for operator safety purposes and to avoid collisions between the tool of the robot and the part this tool is to process. In this case, this is a real part, for example a vehicle prototype, which raises the questions mentioned above.

Finally, the U.S. Pat. No. 6,167,607 B1 simply describes a three-dimensional relocation method by means of a vision system using optical sensors to position a robot or the like and define its movement path.

### SUMMARY OF THE INVENTION

This invention aims to overcome all these disadvantages, in particular by designing a method and a device for implementing this method, which allow facilitating the training or programming of robots intended for carrying out complex tasks on complicated parts, reducing the training time, respecting the confidentiality of the performed tests and working remotely.

This goal is achieved by a method such as described, in which one carries out training of the robot or the like on a 3D virtual model of the part, and in that one associates with the 3D virtual model of the part at least one virtual guide defining a space arranged for delimiting an approach path of the specific tool of the robot onto a predetermined operation area of the 3D virtual model of the part, this predetermined operation area being associated to the virtual guide, and in that one brings the specific tool of the robot onto the predetermined operation area associated to the virtual guide by using this guide and in that one stores the space coordinates of the specific tool of the robot with respect to a given coordinate system in which the 3D virtual model of the part is positioned when this tool is effectively located in the predetermined operation area.

The movements may be carried out with a virtual robot that is the exact image of the real robot used after its training.

One preferably uses a virtual guide having a geometric shape and which delimits a defined space, and one carries out the training of the robot by bringing in a first step the specific tool in the defined space and by moving in a second step the specific tool towards a characteristic point of the virtual guide, this characteristic point corresponding with the predetermined operation area of the 3D virtual model of the part.

The virtual guide may have a conical shape and the characteristic point corresponding with the predetermined operation area of the 3D virtual model of the part is the top of the cone.

The virtual guide can have a spherical shape and the characteristic point corresponding with the predetermined operation area of the 3D virtual model of the part is the center of the sphere.

To improve the use of the method, one can associate at least one test pattern to a work space in which the 3D virtual model of the part and the robot are located, and use at least one camera for making pictures of the work space in order to calibrate the movements of the base of the robot in the work space.

An additional improvement consists in associating at least one first test pattern to a work space in which the 3D virtual model of the part and the robot are located and one second test pattern to the specific tool of the robot, and in using at least one camera for making pictures of the work space in order to calibrate the movements of the base of the robot and those of the specific tool in the work space.

Another improvement consists in associating at least one first test pattern to a work space in which the 3D virtual model of the part and the robot are located, one second test pattern to the specific tool of the robot and at least one third test pattern on at least one of the mobile components of the robot, and in using at least one camera for making pictures of the work space in order to calibrate the movements of the base of the robot, of at least one of its mobile components and those of the specific tool in the work space.

One can advantageously carry out the training operations remotely, using communications through an interface coupled to a control unit of the robot.

This goal is also achieved with a device such as described and which it comprises means to display the part in the form of a 3D virtual model, control means for carrying out the movements of the specific tool, and means for associating with the 3D virtual model of the part at least one virtual guide defining a space arranged for delimiting an approach path of the specific tool of the robot onto a predetermined operation area of the 3D virtual model of the part, this predetermined operation area being associated to the virtual guide, means for bringing the specific tool of the robot onto the predetermined operation area associated to the virtual guide by using this guide and means for storing the space coordinates of the specific tool of the robot, relative to a given coordinate system in which the 3D virtual model of the part is positioned, when this tool is effectively located in the predetermined operation area.

Preferably, the virtual guide has a geometric shape that delimits a defined space, means for bringing in a first step the specific tool in the defined space and means for moving, in a second step, the specific tool towards a characteristic point of the virtual guide, this characteristic point corresponding to the predetermined operation area of the 3D virtual model of the part.

The virtual guide may have a conical shape and the characteristic point corresponding with the predetermined operation area of the 3D virtual model of the part may be the top of the cone.

The virtual guide can have a spherical shape and the characteristic point corresponding with the predetermined operation area of the 3D virtual model of the part may be the center of the sphere.

Preferably, the device includes at least one test pattern associated to a work space in which the 3D virtual model of the part and the robot are located, and at least one camera for making pictures of the work space in order to calibrate the movements of the base of the robot in the work space.

According to a first improvement, the device can include at least one first test pattern associated to a work space in which the 3D virtual model of the part and the robot are located, and at least one second test pattern associated to the specific tool of the robot, as well as at least one camera for making pictures of the work space in order to calibrate the movements of the base of the robot and those of the specific tool in the work space.

According to a second improvement, the device can include at least one first test pattern associated to a work space in which the 3D virtual model of the part and the robot are located, at least one second test pattern associated to the specific tool of the robot, and at least one third test pattern on at least one of the mobile components of the robot, as well as at least one camera for making pictures of the work space in order to calibrate the movements of the base of the robot, of at least one of its mobile components and those of the specific tool in the work space.

### BRIEF DESCRIPTION OF THE DRAWINGS

The present invention and its advantages will be better revealed in the following detailed description of several embodiments intended for implementing the method of the invention, in reference to the drawings in appendix given for information purposes and as non limiting examples, in which:

FIG. 1 is a schematic view representing a first embodiment of the device according to the invention,

FIG. 2 is a schematic view representing a second embodiment of the device according to the invention,

FIG. 3 is a schematic view representing a third embodiment of the device according to the invention,

FIG. 4 is a schematic view representing a fourth embodiment of the device according to the invention, and

FIG. 5 represents a sequence chart illustrating the method of the invention.

### DETAILED DESCRIPTION OF THE PREFERRED EMBODIMENTS

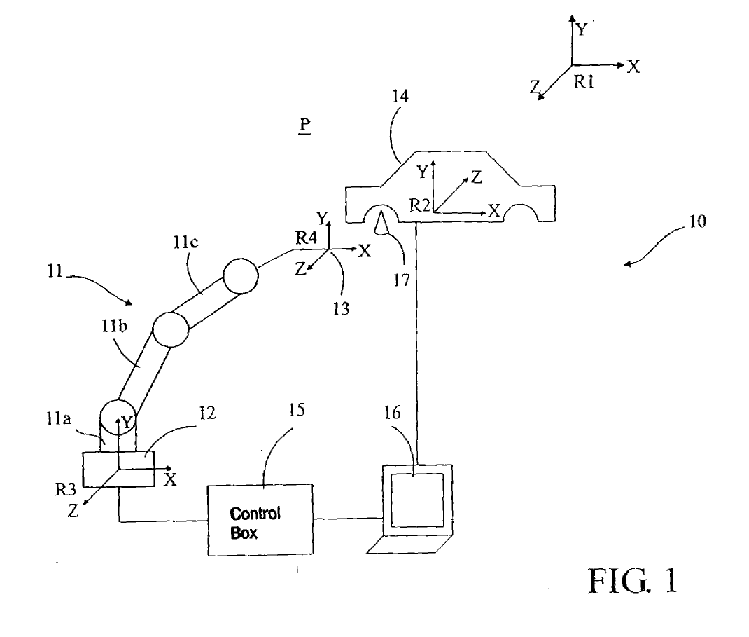

In reference to FIG. 1, the device 10 according to the invention comprises mainly a robot 11 or the like, which is mounted on a base 12 and which carries at least one specific tool 13 for carrying out one or several automated tasks, and in particular various processing, mounting, packaging, maintaining functions. The robot 11, whose characteristic is the number of its movable axes, is designed according to the functions it is to carry out and comprises a certain number of articulated and motorized elements 11a, 11b, 11c for example. The device 10 comprises also a part 14 intended for being processed by the specific tool 13. This part 14, represented under the profile of a motor vehicle, is advantageously a 3D virtual image or virtual model of the part, and the tasks to be carried out by the specific tool 13 of the robot 11 are trained by means of this 3D virtual model of the part in anticipation of future interventions on real parts corresponding to this virtual image. In the continuation of the description, the 3D virtual image or virtual model of the part is called, more simply, “the virtual part 14”.

The device 10 comprises furthermore a control box 15 of the robot 11 that is on the one hand connected with the robot 11 and on the other hand with a classical computer 16. The whole of these elements is located in a work space P, identified by a space coordinate system R1 with three orthogonal axes XYZ, called universal coordinate system. The virtual part 14 is also located using an orthogonal coordinate system R2 with three axes XYZ, which allows defining its position in the work space P. The robot 11 is located using an orthogonal coordinate system R3 with three axes XYZ, mounted on its base 12, which allows defining its position in the work space P. Finally, the specific tool 13 is located using an orthogonal coordinate system R4 with three axes XYZ, which allows defining its position in the work space P.

The virtual part 14 is equipped with at least one virtual guide 17 and preferably with several virtual guides, which have advantageously, but not exclusively, the shape of a cone (as represented) or a sphere (not represented) and whose function will be described in detail below. In the represented example, only one virtual guide 17 is located in the wheel housing of the vehicle that represents the virtual part 14. The cone defines a space arranged to delimit an approach path of the specific tool 13 of the robot 11 onto a predetermined operation area, in this case a precise point of the wheel housing of the virtual part 14. Each virtual guide 17 is intended for ensuring the training of the robot for a given point Pi of the profile of the virtual part 14. When several virtual guides 17 are present, they can be activated and deactivated as required. Their operation consists in “capturing” the specific tool 13 when it is moved by the robot close to the operation area of the virtual part 14 where this specific tool 13 is to carry out a task. When this specific tool 13 penetrates the space delimited by the cone, it is “captured” and its movements are strictly limited in this space so that it reaches directly the operation area, that is the intersection of its movement path and of the virtual line representing the virtual part 14. The top of the cone corresponds precisely with the final position of the specific tool 13. The presence of the cone avoids all unexpected movements of the tool and, consequently, collisions with the real part and/or users. It allows ensuring the final access to the intersection point that corresponds to the operation area of the tool. Since this path is secure, the approach speeds can be increased without danger. When the virtual guide 17 is a sphere, the final position of the specific tool 13, which corresponds to the operation area on the virtual part, may be the center of the sphere.

In FIG. 1, the virtual guide 17 is represented by a cone. This virtual guide 17 could be a sphere or any other suitable shape whose geometric shape can be defined with an equation. The specific tool 13 can be moved manually in this training phase and brought to an intersection with the virtual guide 17 in order to be then taken over automatically or moved manually towards the top of the cone, or the center of the sphere if the virtual guide 17 has a spherical shape. These operations can be repeated at any point or any predetermined operation area of the virtual part 14.

When the robot 11 has brought the specific tool 13 into the predetermined operation area, the space coordinates of this tool are identified with the help of its orthogonal coordinate system R4 and stored in the computer 16. Similarly, one carries out the simultaneous storing of the space coordinates of the robot 11 with the help of its orthogonal coordinate system R3 and the simultaneous storing of the space coordinates of the virtual part 14 or of the concerned operation area with the help of its orthogonal coordinate system R2. These various location operations are carried out in the same work space P defined by the orthogonal coordinate system R1, so that all movement parameters of the robot 11 can be calculated on the basis of the real positions. This way of proceeding allows removing all imperfections of the robot 11 and storing the parameters of the real movements, while working only on a virtual part 14.

Since the “training” is performed on a virtual part 14, it can be remote-controlled, as a remote training with various instructions. The control box 15 of the robot 11 is an interface used to interpret instructions that can be transmitted to it by the operator by means of a keyboard, but also by means of a telephone, of a remote control, of a control lever of the so-called “joystick” type or similar devices. The movements can be monitored remotely on a screen if they are filmed by at least one camera.

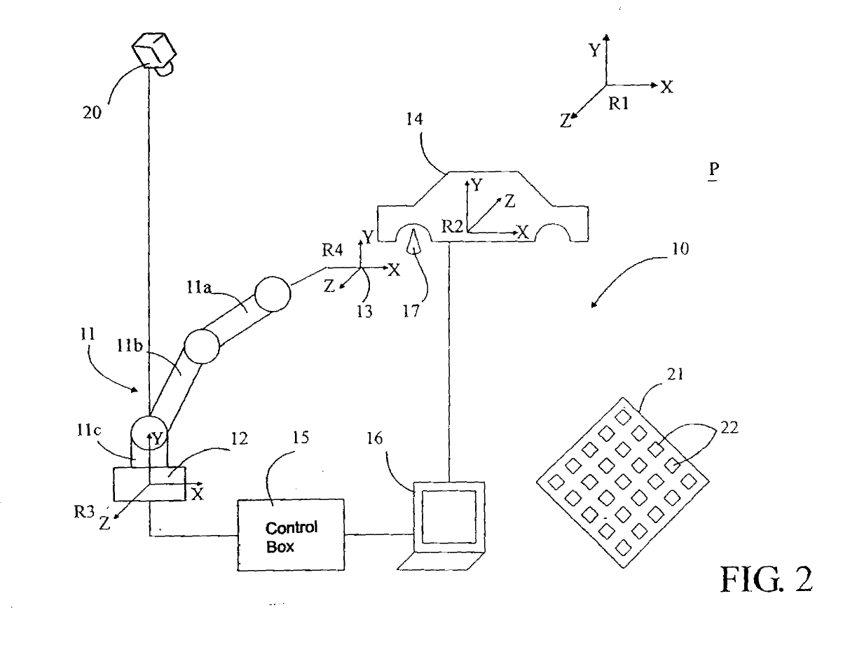

The embodiment illustrated by FIG. 2 represents a first variant that integrates certain improvements with respect to the construction of FIG. 1, but that meets the same requirements with regard to the training of robots. The components of this embodiment variant, which are the same in the first embodiment, bear the same reference numbers and will not be explained more in detail. The device 10 represented comprises, in addition with respect to the embodiment of FIG. 1, at least one camera 20 that is arranged so as to display the robot 11 during all its movements in the work space P identified by the reference system R1 and a test pattern 21 that comprises for example an arrangement of squares 22 having precisely determined dimensions and that are regularly spaced to serve as a measuring standard. The test pattern 21 supplies the dimensions of the work space P in which the robot 11 is moving, and which is called the robotic cell. The camera 20 allows monitoring all movements of the robot 11 and the combination of the camera 20 and test pattern 21 allows calibrating the movements. The dimensional data is stored in the computer 16; it allows carrying out the calculation of the parameters of the movements of the robot 11 and, more particularly, of the tool 13.

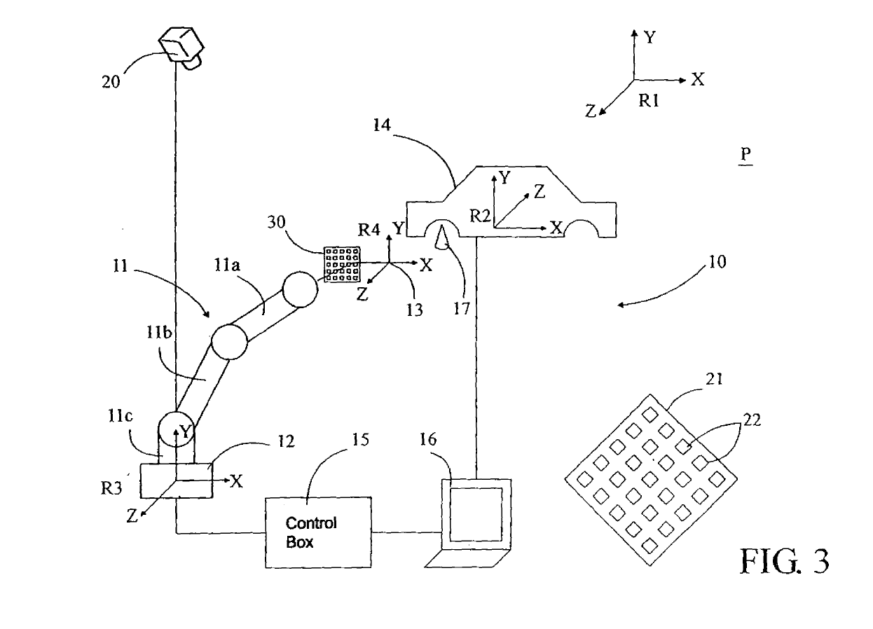

FIG. 3 represents a second variant, more advanced than the previous, which includes in addition a second test pattern 30 associated to the specific tool 13. According to this embodiment, the test pattern 30 is called on-board, because it is directly linked with the head of the robot 11 to identify extremely precisely the parameters of the movements of the tool 13. By this means, the user will have in the same time the accurate follow-up values of the base 12 of the robot 11, but also the accurate follow-up values of the specific tool 13. The space coordinates are acquired with a high accuracy and the parameters of the movements are also determined with a high accuracy, while eliminating all handling errors, since the positions are determined on the real robot.

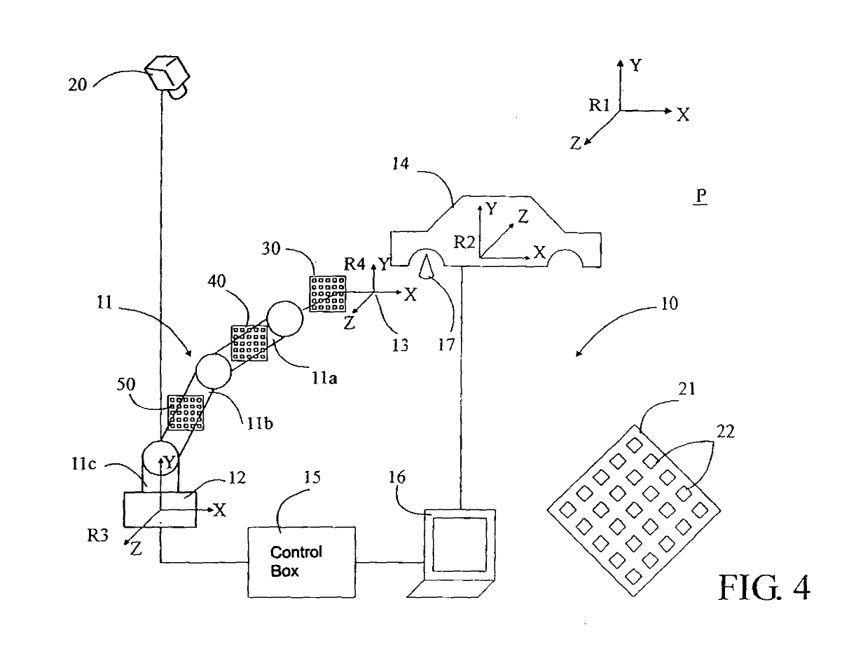

An additional improvement is brought by the variant according to FIG. 4, which finally includes a series of additional test patterns 40, 50 (or more), associated respectively to each mobile element 11a, 11b, 11c of the robot 11. According to this embodiment, the test patterns 30, 40 and 50 are called on-board, because they are directly linked with the mobile elements of the robot 11 to identify extremely precisely the parameters of the movements of all these elements during operation. In this embodiment, it is possible do calibrate the movements of the robot 11 with its tool 13 and its fittings.

It is of course understood that the transmission of the scene of the work space P may occur by means of a set of mono or stereo-type cameras 20. These cameras 20 can be equipped with all classical setting elements, setting of the focus for the quantity of light, setting of the aperture for the sharpness, setting of the objective for the magnification, etc. These settings may be manual or automatic. A calibration procedure is required to link all coordinate systems R2, R3, R4 of the device 10 and to express them in one single coordinate system that is, for example the coordinate system R1 of the work space P.

The remote handling, remote programming or remote training task, as it is described above, is carried out on a virtual scene by involving a real robot and a 3D virtual model of the real part. In practice, during this training, the graphic interface of the computer takes in charge the representation, on the same display, of the superposition of a setpoint path with the virtual and/or real part.

The coordinate system defining the impact point of the tool 13 loaded on the robot 11, which is for example a six axes robot: X, Y, Z, which are orthogonal axes with a linear movement, and W, P, R, which are rotary axes, will be more commonly called impact coordinate system. The point defining the desired impact on the virtual part 14 will be called impact point Pi. The impact point whose coordinates are (x, y, z, w, p, r) is expressed in the so-called universal coordinate system R1.

In order to facilitate the remote handling, remote programming or remote training of the controlled articulated structure, that is to say the robot 11, each point of the path will be equipped, according to the need and in function of the choice of the operator, with a virtual guide 17 having an usual shape, of spherical or conical or of another type. The virtual guide 17 is used to force the training towards the coordinate system simulating the impact point of the tool 13 loaded on the robot 11 towards the desired impact point Pi. This operation may be carried out in three ways:

1. by using the coordinates, measured by the robot 11, of its impact point and integrating them in the device 10 comprising cameras 20 and spherical or conical virtual guides 17 whose equations are respectively:
a. Spherical with the equation

Where
R is the radius of the sphere (x−x₀)²=(y−y₀)²=(z−z₀)²=R²
   x₀, y₀ and z₀ are the coordinates of the center of the sphere corresponding to the point of the path, expressed in the universal coordinate system R1
x, y and z are the coordinates of any point belonging to the sphere, expressed in the universal coordinate system R1.

$${b . Conical equation x - {x}_{0} )}^{2} + {( y - {y}_{0} )}^{2} = {( \frac{r}{h} )}^{2} {( z - {z}_{0} )}^{2} .$$

Where
r is the radius of the base of the cone and h its height
   x₀, y₀ and z₀ are the coordinates of the top of the cone corresponding to the point of the path, expressed in the universal coordinate system R1
   x, y and z are the coordinates of any point belonging to the cone expressed in the universal coordinate system R1.
Or even of any geometrical shape whose equation can be written in a form f(x,y.z)=0, where x, y and z are the coordinates of any point belonging to this shape, expressed in the universal coordinate system R1.

2. by using a test pattern 30 mounted on the tool 13 and allowing the measurement by the cameras 20 of its instantaneous position, thus doing without the measurements of the robot 11.

3. by using the virtual model of the robot, which has been reconstructed thanks to the measurement of the cameras and according to the principle described above.

Consequently, the training or remote training help algorithm for the path of the robot 11 consists in identifying in real time the position of the impact coordinate system of the robot with respect to the virtual guide 17. When the impact coordinate system and the virtual guide 17 intersect, the virtual guide will prevent the impact coordinate system from exiting the guide and will force the impact coordinate system to move only towards the impact point, which is the center of the sphere or the top of the cone for example. The operator can decide whether or not he activates the assistance or the automatic guidance in the space defined by the virtual guide 17.

At the moment of the activation of the automatic guidance, the device 10 is arranged so as to validate the training of the robot 11 with respect to a point whose x, y and z coordinates are the coordinates of the center of the sphere or the coordinates of the top of the cone, according to the shape of the virtual coordinate system. The orientations w, p and r, respectively called roll, pitch and yaw are those of the last point reached by the operator.

The device 10 is arranged so as to carry out comparative positioning calculations between the virtual part and/or a real part or between two virtual parts or between two real parts, according to the planned configuration. This calculation will be assigned directly to the path of the robot, for a given operation. This calculation may be either single, upon request, or carried out continuously in order to re-position the parts at every cycle during the production.

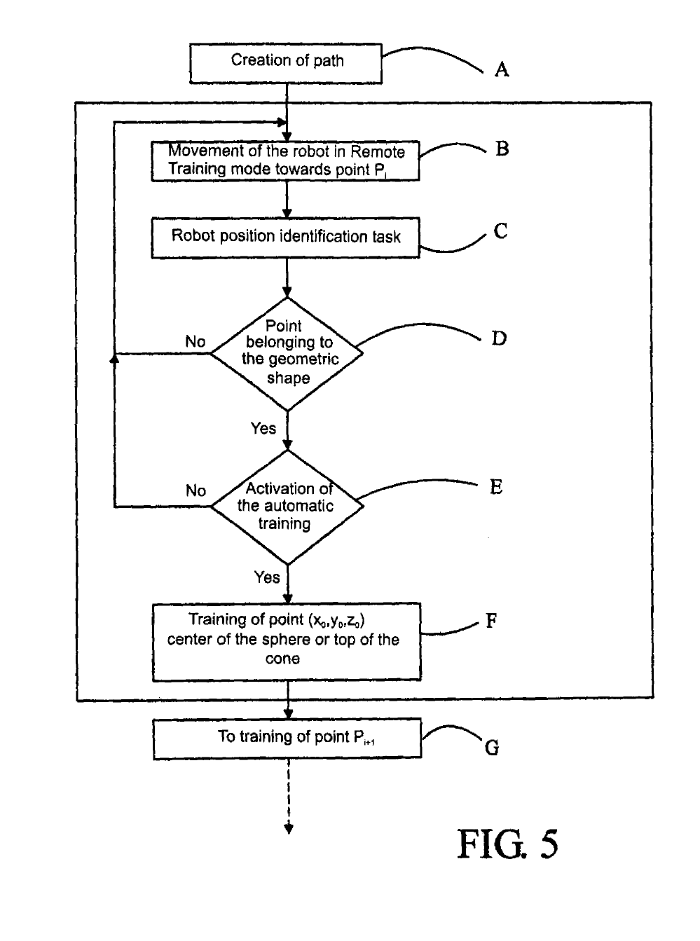

The operating mode described above is illustrated by FIG. 5, which represents a flowchart of functions corresponding to the method of the invention. This operating mode includes the following steps:

A.—the initial phase represented by box A expresses the fact of creating a path;

B.—the phase represented by box B consists in moving the robot 11 in training or remote training mode towards an impact point Pi of the virtual part 14;

C.—the phase represented by box C consists in identifying the position of the robot 11;

D.—the phase represented by box D consists in checking whether YES or NO the impact point Pi belongs to the virtual part 14. If the answer is negative, the training is interrupted. If the answer is positive, the process continues;

E.—the phase represented by box E consists in deciding whether YES or NO the automatic training by means of a virtual guide 17 is activated. If the answer is negative, the training is interrupted. If the answer is positive, the process continues;

F.—the phase represented by box F consists in storing the coordinates of the center of the sphere or the top of the cone of the corresponding virtual guide 17;

G.—the phase represented by box G consists in storing the coordinates of the impact point.

To sum up, the advantages of the method are mainly the following:
It allows creating directly the path on the virtual part 14 during the development without requiring the real prototype;
It allows creating the path remotely by means of any kind of communication network;
It allows taking directly into consideration the constraints of the environment of the robot 11, such as the size and the movements of the fittings of this robot;
It allows avoiding to have an approximate training of the points, with the eye, thanks to the virtual guides 17, which leads to an improvement of the quality of the processed part;
It allows calculating the cycle times of the robot 11 accurately since the work is carried out on the real robot or on its virtual image, which corresponds exactly to the real robot;
It allows performing a three-dimensional re-positioning of the path of the robot 11 by comparing the positioning of the virtual part 14 and that of the real part;
It allows avoiding any risk of collision between the robot 11 and the real part and/or the operator, since the latter uses a video feedback from the camera(s) 20;
It allows taking directly into consideration the virtual model of the robot 11 and generating a first rough outline of the paths, without the constraints of the production conditions.

The present invention is not limited to the embodiments described as non-limiting examples, but it extends to any evolutions remaining within the scope of acquired knowledge of the persons skilled in the art.

1-16. (canceled)

17. A method of training a robot (11), the robot being adapted to carry out automated tasks in order to accomplish one of processing, mounting, packaging and maintaining tasks, using a specific tool (13) on a part (14), the training being carried out to define precisely movements of the specific tool of the robot requested within a framework of the tasks to be accomplished on the part and to store parameters of the movements of the specific tool (13) of the robot (11), the method comprising the steps of:
performing the training of the robot on a 3D virtual model of the part (14),
associating to the 3D virtual model of the part (14) at least one virtual guide (17) defining a space arranged for delimiting an approach path of the specific tool (13) of the robot (11) onto a predetermined operation area of the 3D virtual model of the part (14), and the predetermined operation area being associated to the virtual guide (17),
bringing the specific tool (13) of the robot (11) into the predetermined operation area associated to the virtual guide (17) using guide and storing space coordinates of the specific tool (13) of the robot (11), with respect to a given coordinate system (R1) in which the part (14) is positioned, when the specific tool (13) is effectively located in the predetermined operation area.

18. The method according to claim 17, further comprising the step of ensuring that the robot (11) is an exact 3D virtual image of a robot that is to be used in following training of the robot (11).

19. The method according to claim 17, further comprising the step of ensuring that the virtual guide (17) has a geometric shape which delimits a defined space, and carrying out the training of the robot (11) by bringing the specific tool (13) into the defined space, during one step, and by moving the specific tool (13) towards a characteristic point of the virtual guide (17), during a subsequent step, with the characteristic point corresponding with the predetermined operation area of the 3D virtual model of the part (14).

20. The method according to claim 19, further comprising the step of utilizing, as the virtual guide (17), a conical shape and the characteristic point corresponding with the predetermined operation area of the 3D virtual model of the part (14) is a top of the cone.

21. The method according to claim 19, further comprising the step of utilizing, as the virtual guide (17), a spherical shape and the characteristic point corresponding with the predetermined operation area of the 3D virtual model of the part (14) is a center of the spherical shape.

22. The method according to claim 17, further comprising the step of associating at least one test pattern (21) to a work space (P) in which the 3D virtual model of the part (14) and the robot (11) are located, and using at least one camera (20) for making pictures of the work space (P) for calibrating movements of a base (12) of the robot (11) in the work space (P).

23. The method according to claim 17, further comprising the step of associating at least one first test pattern (21) to a work space (P) in which the 3D virtual model of the part (14) and the robot (11) are located, and one second test pattern (30) associated to the specific tool (13) of the robot (11) and using at least one camera (20) for making pictures of the work space (P) for calibrating movements of a base (12) of the robot (11) and the specific tool (13) in the work space (P).

24. The method according to claim 17, further comprising the steps of associating at least a first test pattern (21) to a work space (P) in which the 3D virtual model of the part (14) and the robot (11) are located, a second test pattern (30) associated to the specific tool (13) of the robot and at least a third test pattern (40, 50) on at least one mobile component (11a, 11b, 11c) of the robot (11), and
using at least one camera (20) for generating pictures of the work space (P) to calibrate movements of a base (12) of the robot (11), the at least one mobile component (11a, 11b, 11c) of the robot (11) and the specific tool (13) in the work space (P).

25. The method according to claim 17, further comprising the step of carrying out training operations remotely using communications through an interface coupled to a control unit (15) of the robot (11).

26. A device (10) for training a robot (11) in which the robot being adapted to carry out automated tasks to accomplish at least one processing, mounting, packaging and maintaining task, using a specific tool (13) on a part (14), the training being carried out to define precisely movements of the robot requested within a framework of the tasks and determine and store parameters of the movements for implementation, the device comprising:
a means for associating to a 3D virtual model of the part (14) at least one virtual guide (17) defining a space arranged for delimiting an approach path of the specific tool (13) of the robot (11) onto a predetermined operation area of the 3D virtual model of the part (14), the predetermined operation area being associated to the virtual guide (17),
a means for bringing the specific tool (13) of the robot (11) onto the predetermined operation area associated to the virtual guide (17) by using the guide and
a means (16) for storing space coordinates of the specific tool (13) of the robot, relative to a given coordinate system (R1), in which the 3D virtual model of the part (14) is positioned, when the tool is effectively located within the predetermined operation area.

27. The device according to claim 26, wherein the virtual guide (17) has a geometric shape which delimits a defined space, and the means for bringing the specific tool (13) in the defined space, during a first step, and a means for moving the specific tool (13) towards a characteristic point of the virtual guide (17), during a second step, in which the characteristic point corresponds with the predetermined operation area of the 3D virtual model of the part (14).

28. The device according to claim 27, wherein the virtual guide (17) has a conical shape and the characteristic point, which corresponds with the predetermined operation area of the 3D virtual model of the part (14), is a top of the conical shape.

29. The device according to claim 27, wherein the virtual guide (17) has a spherical shape and the characteristic point, which corresponds with the predetermined operation area of the 3D virtual model of the part (14), is a center of the spherical shape.

30. The device according to claim 26, wherein at least one test pattern (21) is associated with a work space (P) in which the 3D virtual model of the part (14) and the robot (11) are located, and at least one camera (20) is provided for generating pictures of the work space (P) for calibrating movements of the base (12) of the robot (11) in the work space (P).

31. The device according to claim 26, wherein at least one first test pattern (21) is associated to a work space (P) in which the 3D virtual model of the part (14) and the robot (11) are located, and at least one second test pattern (30) is associated with the specific tool (13) of the robot, and at least one camera (20) for generating pictures of the work space for calibrating movements of a base of the robot (12) and the specific tool (13) in the work space (P).

32. The device according to claim 26, wherein at least one first test pattern (21) is associated with a work space (P) in which the 3D virtual model of the part (14) and the robot (11) are located, at least one second test pattern (30) is associated with the specific tool (13) of the robot and at least one third test pattern (40, 50) is provided on at least one of the mobile components (11a, 11b, 11c) of the robot, and at least one camera (20) for generating pictures of the work space for calibrating movements of a base (12) of the robot, at least one of the mobile components (11a, 11b, 11c) of the robot and the specific tool (13) in the work space (P).

33. A method of training and precisely defining movements of a robot (11) to carry out automated functions using a specific tool (13) on a part (14), the method comprising the steps of:
providing a 3D virtual model of the part (14);
associating at least one virtual guide (17) with the 3D virtual model of the part (14), the virtual guide (17) defining a space which delimits an approach path of the specific tool (13) to a predetermined operation area of the 3D virtual model of the part (14), and the predetermined operation area being associated to the virtual guide (17);
maneuvering the specific tool (13) of the robot (11) using the virtual guide (17), and the predetermined operation area being associated with the virtual guide (17);
storing spacial coordinates of the specific tool (13) of the robot (11) at which the specific tool (13) is positioned, when the specific tool (13) is effectively located within the predetermined operation area, and the spacial coordinates relating to a coordinate system (R1); and
storing parameters of the movements of the specific tool (13) of the robot (11).
